(19) United States
(12) Patent Application Publication
(10) Pub. No.: US 2010/0080603 A1
(43) Pub. Date: Apr. 1, 2010

(54) Method of Forming Registration Mark and Image Forming Apparatus

(75) Inventor: Osamu Takahashi, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/413,077

(22) Filed: Mar. 27, 2009

(30) Foreign Application Priority Data
Mar. 31, 2008 (JP) 2008-089726

(51) Int. Cl. G03G 15/00; G03G 15/01

(52) U.S. Cl. 399/72; 399/301

(57) ABSTRACT

A method of forming registration marks and an image forming apparatus are provided. The registration mark includes two first patterns and one second pattern on an image carrier. The method includes: forming two first patterns on the image carrier; and forming a second pattern on the image carrier between the two first patterns. A specular reflection component in a light reflected by the second pattern is less than a specular reflection component in a light reflected by the image carrier. A diffuse reflection component in a light reflected by the second pattern is less than a diffuse reflection component in a light reflected by the first pattern.

### CROSS-REFERENCE TO RELATED APPLICATIONS

This application claims priority from Japanese Patent Application No. 2008-089726 filed on Mar. 31, 2008, the entire contents of which are incorporated herein by reference.

### TECHNICAL FIELD

Methods and apparatuses consistent with the present invention relate to registration mark and, more particularly, to the formation and reading of registration mark.

### DESCRIPTION OF RELATED ART

In a related art color image forming apparatus, registration marks of respective colors are formed on a surface of an image carrier such as a conveyor belt rotating in association with an operation of a process cartridge, and a shift in the images of the respective colors, etc., is corrected by detecting positions at which the registration marks are formed. The registration marks are scanned on the basis of a specular reflecting light of a light radiated onto the conveyor belt. That is, a sensor that detects a specular reflecting light is provided in the image forming apparatus, and when a detected light volume by the sensor decreases, it is estimated that the sensor faces a registration mark.

Further, in of the related art image forming apparatus, when there is a scratch, etc., on the conveyor belt, a light volume of specular reflecting light decreases at a position of the scratch, which may falsely detect the scratch as a registration mark. Accordingly, Japanese Published Unexamined Patent Application No. 2003-122082 describes a technique for addressing such false detections and proposes that a registration mark be formed along a moving direction of the conveyor belt so as to have a length from which a scratch, etc., can be sufficiently distinguished, and only when alight volume of a specular reflecting light decreases continuously during a predetermined time, is the position estimated as a registration mark.

However, the related art color image forming apparatuses and techniques have a number of disadvantages. For example, in a case of registration marks of chromatic colors such as cyan, magenta, and yellow, if the widths of the registration marks are broad, diffuse reflecting lights from the registration marks increase. The sensor that detects specular reflecting light is incapable of distinguishing the diffuse reflecting light from a specular reflecting light. Thus, there is a disadvantage in that, because very little diffuse reflecting light is generated in a case of a black registration mark, a detected light volume greatly decreases at a central part of the registration mark. However, in a case of a registration mark of a chromatic color, the diffuse reflecting light becomes intense near the center thereof, which suppresses a decrease in a detected light volume. In this case, it is advantageous to make a threshold value for detecting the registration marks smaller. However, when the threshold value is made smaller, it becomes more difficult to prevent scratches, etc., from being falsely detected as registration marks.

Additionally, in the sensor for detecting the specular reflecting light, a range in which the specular reflecting light from the conveyor belt can be detected is not necessarily positioned at the center of a range in which a diffuse reflecting light from the conveyor belt enters into the sensor. Therefore, another disadvantage arises in that, when a diffuse reflecting light becomes strong, an offset may occur in which a position at which a detected light volume greatly decreases is shifted from a center of a registration mark.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the disadvantages described above.

Accordingly, illustrative aspects of the present invention provide a method of forming a registration mark and an image forming apparatus which are capable of minimizing an effect of diffuse reflecting light such that scratches are less likely to be falsely detected as registration marks, and a registration mark which are capable of minimizing the occurrence of an offset.

According to an illustrative aspect of the present invention, there is provided a method for forming a registration mark on an image carrier. The registration mark comprises two first patterns and one second pattern. The method comprises: forming two first patterns on the image carrier; and forming a second pattern on the image carrier between the two first patterns; wherein a specular reflection component in a light reflected by the second pattern is less than a specular reflection component in a light reflected by the image carrier; and wherein a diffuse reflection component in a light reflected by the second pattern is less than a diffuse reflection component in a light reflected by the first pattern.

According to another illustrative aspect of the present invention, there is provided an image forming apparatus. The image forming apparatus comprises: an image forming unit which forms images by using developers of a plurality of colors; an image carrier that rotates in association with an image-forming operation of the image forming unit; a mark formation control unit which controls the image forming unit to form at least one registration mark on the image carrier, the registration mark comprising two first patterns and one second pattern, the second pattern is located between the two first patterns; an irradiating unit which irradiates the registration mark with light; and a light detecting unit which detects a light reflected by the registration mark, wherein a specular reflection component in a light reflected by the second pattern is less than a specular reflection component in a light reflected by the image carrier, and wherein a diffuse reflection component in a light reflected by the second pattern is less than a diffuse reflection component in a light reflected by the first pattern.

### BRIEF DESCRIPTION OF THE DRAWINGS

FIG. 1 is a side sectional view schematically showing an example of a configuration of a laser printer to which exemplary embodiments of the present invention are applied.

FIG. 2 is an explanatory diagram schematically showing an example of a configuration of a registration mark sensor of the laser printer of FIG. 1.

FIG. 3 is a circuit diagram showing an example of an electrical configuration of the registration mark sensor of FIG. 2.

FIG. 4 is a block diagram showing an example of a configuration of a control system of the laser printer of FIG. 1.

FIG. 5 is a flowchart showing an auto-registration processing executed by the control system of FIG. 4.

FIGS. 6A to 6C are explanatory diagrams showing sensing of homochromatic strip-shaped registration marks.

FIGS. 7A to 7D are explanatory diagrams showing an example of a configuration of registration marks according to an exemplary embodiment of the present invention.

FIGS. 8A to 8C are explanatory diagrams showing a width of a registration mark pattern.

FIGS. 9A and 9B are explanatory diagrams showing a change in a sensor output at a time of detecting the registration mark of FIG. 7A.

FIGS. 10A to 10C are explanatory diagrams showing an example of a configuration of a modification of the registration marks.

### DESCRIPTION OF EXEMPLARY EMBODIMENTS

Next, an exemplary embodiment of the present invention will be described with reference to the drawings. Note that, in the exemplary embodiments which will be hereinafter described, the present invention is applied to a so-called laser printer which is coupled to a computer.

### 1. External Configuration of Laser Printer

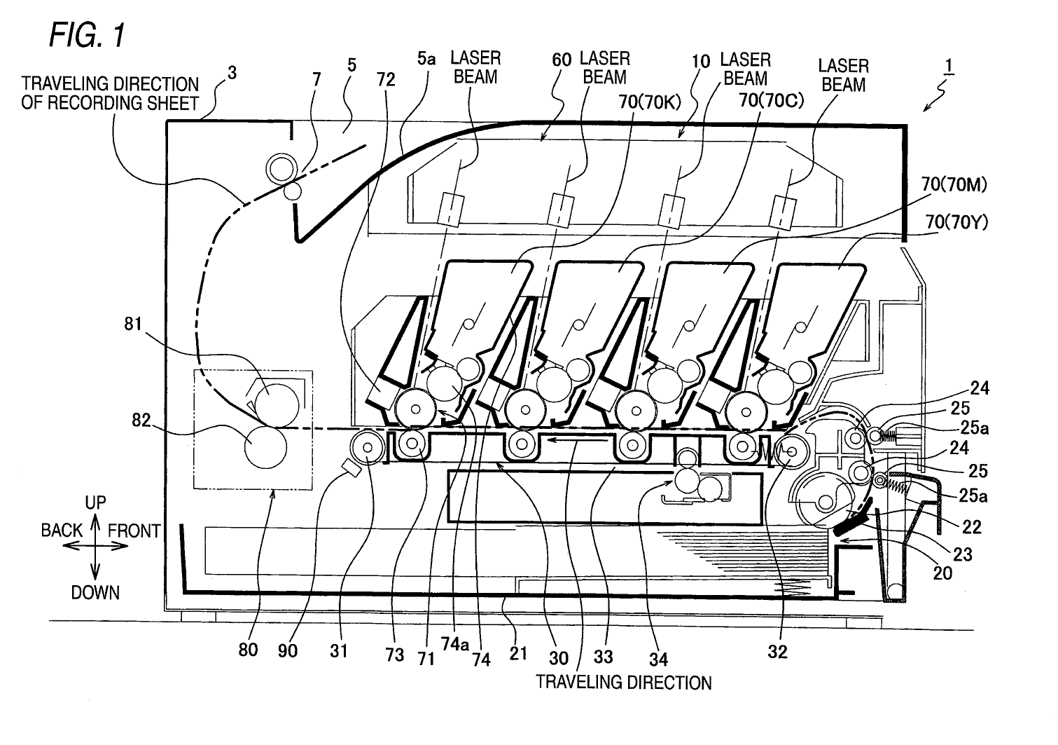

FIG. 1 is a side sectional view schematically showing an example of a configuration of a laser printer 1. The laser printer 1 is installed so that the upper side in FIG. 1 is upward in the direction of gravitational force, and is usually used so as to set the right side in FIG. 1 as the front side. Then, a case 3 of the laser printer 1 is formed into a substantially box shape (cubic shape), and a catch tray 5 on which recording sheets (corresponding to media to be recorded) such as papers or overhead projector (OHP) sheets to be discharged from the case 3 after completion of printing is provided at the upper surface side of the case 3.

Note that, in this exemplary embodiment, a frame member (not shown) formed of metal or resin is provided inside the case 3. A process cartridge 70, a fixing unit 80, etc., which will be described later are assembled so as to be detachable from the frame member provided inside the case 3.

Further, the catch tray 5 includesan inclined surface 5a inclined so as to come down from the upper surface of the case 3 as the catch tray 5 goes backward, and a discharge unit 7 to which recording sheets after completion of printing are discharged is provided at the rear end side of the inclined surface 5a.

### 2. Internal Mechanical Structure of Laser Printer

An image forming unit 10 includes an image forming means for forming an image on a recording sheet. A feeder unit 20 feeds a recording sheet to the image forming unit 10. A conveyance mechanism 30 is a conveying means which passes through portions facing four process cartridges 70Y, 70M, 70C, and 70K to convey a recording sheet.

Further, a registration mark sensor 90 is a sensor for detecting a registration mark formed on the surface of a conveyor belt 33. The conveyor belt 33 is an example of a body of rotation which will be described in more detail later. Then, after completion of image formation on a recording sheet in the image forming unit 10, the recording sheet is turned to change its traveling direction upward in a discharge chute (now shown), and the recording sheet is discharged to the catch tray 5 from the discharge unit 7.

2.1. Configuration of Feeder Unit

The feeder unit 20 includes a sheet feed tray 21 housed in the lowermost part of the case 3, a sheet feed roller 22 which is provided above the front end of the sheet feed tray 21 to feed a recording sheet placed on the sheet feed tray 21 to the image forming unit 10, and a separating pad 23 which is installed at a place facing the sheet feed roller 22, that provides conveying resistance to a recording sheet to separate recording sheets one piece by one piece.

Then, a recording sheet placed on the sheet feed tray 21 is turned around at the front side in the case 3, to be conveyed to the image forming unit 10 installed at the substantially central part in the case 3. Therefore, a conveyor roller 24 which is curved in a substantially U-shape, that applies conveying force to a recording sheet to be conveyed to the image forming unit 10, is installed at the place turned so as to be a substantially U-shape of a recording sheet traveling route from the sheet feed tray 21 to the image forming unit 10.

Note that a pressure roller 25 which presses down a recording sheet onto the conveyor roller 24 is installed at a place facing the conveyor roller 24 so as to place the recording sheet therebetween, and the pressure roller 25 is pressed toward the conveyor roller 24 by an elastic means such as a coil spring 25a, etc.

2.2. Configuration of Conveyance Mechanism

The conveyance mechanism 30 includes a driving roller 31 that rotates in association with an image-forming operation of the image forming unit 10, a driven roller 32 which is installed so as to be rotatable at a position distant from the driving roller 31, the conveyor belt 33 installed so as to bridge between the driving roller 31 and the driven roller 32, etc. The conveyor belt 33 is an example of an image carrier. Then, the recording sheet conveyed from the sheet feed tray 21 is conveyed sequentially to the four process cartridges 70Y, 70M, 70C, and 70K due to the conveyor belt 33 on which the recording sheet is placed rotating. Note that the conveyance mechanism 30 includes the driving roller 31, the driven roller 32, and the conveyor belt 33 as an integrated unit, and is configured to be exchangeable accordingly by opening the upper cover of the case 3. Further, a belt cleaner 34 for erasing a registration mark which is formed on the surface of the conveyor belt 33 and which will be described later, is installed under the conveyor belt 33.

2.3. Configuration of Image Forming Unit

The image forming unit 10 includes a scanner unit 60, the process cartridge 70, the fixing unit 80, etc. Further, the image forming unit 10 according to the exemplary embodiment is in a so-called direct tandem system which is capable of color printing.

In the exemplary embodiment, the four process cartridges 70Y, 70M, 70C, and 70K corresponding to four-color toners (developers) of yellow, magenta, cyan, and black (black color) are installed so as to be arrayed in tandem along the traveling direction of a recording sheet from the upstream of the traveling direction of the recording sheet. Note that the four process cartridges 70Y, 70M, 70C, and 70K are different in toner color, but the same in other points. Hereinafter, the four process cartridges 70Y, 70M, 70C, and 70K are collectively called the process cartridge 70.

The scanner unit 60 is provided in the upper portion in the case 3, to form an electrostatic latent image on the surface of a photoconductor drum 71 as an example of an electrostatic latent image carrier provided to each of the four process cartridges 70Y, 70M, 70C, and 70K. In detail, the scanner unit 60 includes a laser light source, a polygon mirror, an fθ lens, a reflecting mirror, etc.

The process cartridge 70 is installed in the case 3 so as to be detachable under the scanner unit 60. The process cartridge 70 comprises the photoconductor drum 71, an electrizer 72, a developing cartridge 74 having a developing roller 74a, etc. The developing roller 74a is an example of a developing means. Note that the photoconductor drums 71 of the respective process cartridges 70 respectively face the four transfer rollers 73 provided as part of the conveyance mechanism 30, and portions of the photoconductor drums 71 facing the four transfer rollers 73 correspond to four transcriptional parts corresponding to the respective colors.

The fixing unit 80 is installed downstream from the photoconductor drums 71 in the traveling direction of a recording sheet. The fixing unit BO heats and melts toners transcribed onto the recording sheet to fix the toners thereto. In detail, the fixing unit 80 includes a heating roller 81 which is installed on the printing surface side of a recording sheet, to apply conveying force to the recording sheet while heating toners, a pressure roller 82 which is installed at a side opposite to the heating roller 81 so as to place the recording sheet therebetween; to press the recording sheet toward the heating roller 81, etc.

Then, in the image forming unit 10, an image is formed on the recording sheet as follows. That is, the surface of the photoconductor drum 71 is positively-charged uniformly by the electrizer 72 as the photoconductor drum 71 rotates. Thereafter, the surface of the photoconductor drum 71 is exposed by high-speed scanning of a laser beam radiated from the scanner unit 60. Thereby, an electric potential of an exposed area becomes lower than an electric potential of an unexposed area, which forms an electrostatic latent image corresponding to an image to be formed on the recording sheet, on the exposed area on the surface of the photoconductor drum 71.

Next, by applying developing bias to the developing roller 74a while rotating the developing roller 74a provided to the process cartridge 70, a nonmagnetic one-component toner which is supported on the developing roller 74a and positively-charged, is fed onto the electrostatic latent image formed on the surface of the photoconductor drum 71, i.e., the exposed portion exposed by the laser beam so as to lower an electric potential of the exposed portion on the surface of the photoconductor drum 71 which is positively-charged uniformly when the toner faces and contacts the photoconductor drum 71. Thereby, the electrostatic latent image on the photoconductor drum 71 is made into a visible image, and a toner image due to reversal development is supported on the surface of the photoconductor drum 71.

Thereafter, the toner image supported on the surface of the photoconductor drum 71 is transcribed onto the recording sheet by transcribing bias applied to the transfer roller 73. Then, the recording sheet on which the toner image is transcribed is conveyed to the fixing unit 80 to be heated, and the toner transcribed as the toner image is fixed to the recording sheet, which completes the image formation (printing).

2.4. Configuration of Registration Mark Sensor

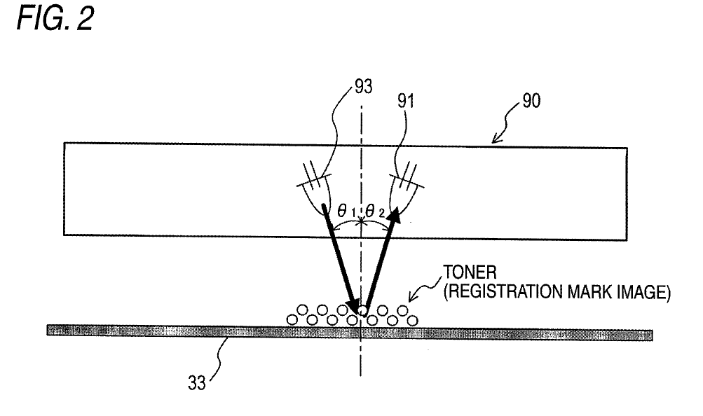

FIG. 2 is an explanatory diagram schematically showing the configuration of the registration mark sensor 90.

As shown in FIG. 2, the registration mark sensor 90 has an infrared light-emitting diode 93 as an example of an irradiating means for irradiating the conveyor belt 33 with an infrared light, and a phototransistor 91 as an example of a specular reflecting light detecting means for detecting a light volume (intensity) of an infrared light specularly reflected at an angle θ2 which is the same as an incident angle θ1 of an infrared light radiated at the conveyor belt 33 from the infrared light-emitting diode 93.

As the conveyor belt 33, a material in which carbon is dispersed in a film serving as a belt material is used in order to obtain an electric characteristic for transcribing toners. Therefore, the surface of the conveyor belt 33 is black, which absorbs infrared light in order not to generate diffuse reflection. However, because the surface is finished at a high degree of brilliance, this brilliance provides a characteristic of generating a great amount of specular reflection. Therefore, in a state in which a registration mark is not formed on the conveyor belt 33, the phototransistor 91 detects a high-intensity infrared light.

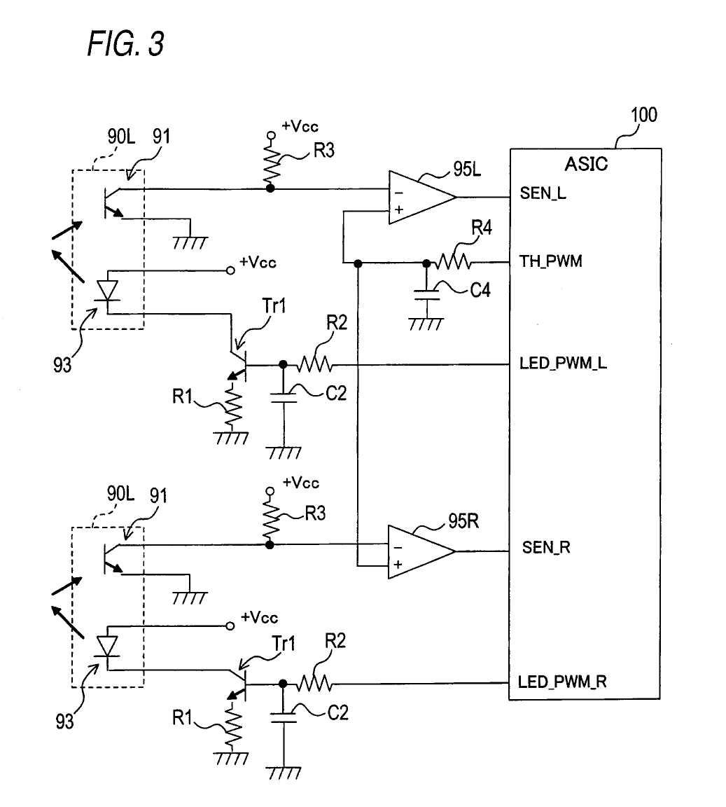

FIG. 3 is a circuit diagram showing the electrical configuration of the registration mark sensor 90. As shown in FIG. 3, the registration mark sensor 90 is provided as registration mark sensors 90R and 90L on the right and left, respectively, of the conveyor belt 33, and the electrical configurations of both are the same. Herein, the registration mark sensors 90R and 90L are simply called the registration mark sensor 90 in a case in which there is no need to distinguish between the right and left registration mark sensors.

As shown in FIG. 3, the infrared light-emitting diode 93 of each of the registration mark sensors 90 is connected between a direct-current power source (+Vcc) and a collector of a transistor Tr1, and an emitter of the transistor Tr1 is set via a resistor R1. Further, a PWM (Pulse Width Modulation) signal output from an ASIC (application specific integrated circuit) 100 is input to the base of the transistor Tr1 via a smoothing circuit including a resistor R2 and a capacitor C2. Therefore, the infrared light-emitting diode 93 of the registration mark sensor 90L emits a light of intensity corresponding to a duty cycle of a PWM signal output from an LED_PWM_L terminal of the ASIC 100 provided so as to correspond to the infrared light-emitting diode 93, and the infrared light-emitting diode 93 of the registration mark sensor 90R emits light of intensity corresponding to a duty cycle of a PWM signal output from an LED_PWM_R terminal of the ASIC 100 provided so as to correspond to the infrared light-emitting diode 93.

Further, with respect to the phototransistor 91 of each of the registration mark sensors 90, an emitter is grounded and a collector is connected to a direct-current electric source (+Vcc) via a resistor R3, and a voltage of the collector (hereinafter called a sensor output as well) is input to each inverting input terminal of comparators 95L and 95R. A PWM signal output from the TH_PWM terminal of the ASIC 100 is input to each non-inverting input terminal of the comparators 95L and 95R via a smoothing circuit having a resistor R4 and a capacitor C4. Therefore, a voltage corresponding to a duty cycle of a PWM signal output from the TH_PWM terminal (hereinafter called a comparator threshold value as well) and the above-described sensor output are compared in each of the comparators 95L and 95R, and an output therefrom is input to an SEN_L terminal or an SEN_R terminal of the ASIC 100.

### 3. Configuration of Control System of Laser Printer

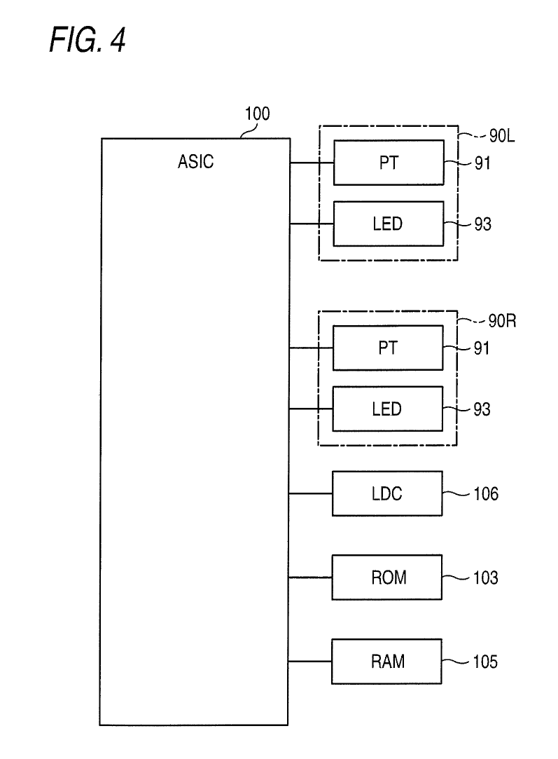

Next, FIG. 4 is a block diagram showing an example of a configuration of a control system of the laser printer 1 configured as described above. As shown in FIG. 4, not only are the registration mark sensors 90R and 90L connected to the ASIC 100 via the above-described circuits, but also a ROM (read only memory) 103 storing various programs therein, a RAM (random access memory) 105 for temporarily storing various data therein, an LD control unit 106 that controls laser light sources corresponding to the respective colors of the scanner unit 60, etc., are connected to the ASIC 100.

### 4. Control in the Control System

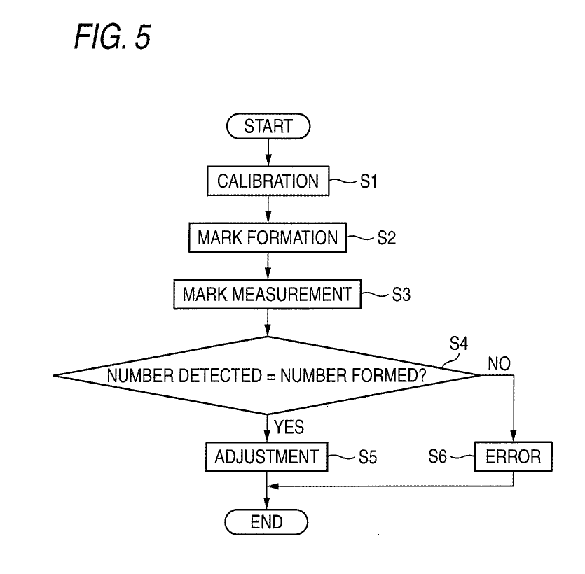

Next, the control executed by the ASIC 100 will be described. FIG. 5 is a flowchart showing auto-registration processing executed at the time of instructing auto-registration in which a registration mark is formed on the conveyor belt 33 and a correction for color shift is performed in a timing such as at a power-on time. The timing may be predetermined.

As shown in FIG. 5, when auto-registration is instructed to start the processing, at S1 (S denotes an operation, and will be omitted hereinafter), processing for calibrating the respective registration mark sensors 90R and 90L is executed. This processing is processing in which the aforementioned comparator threshold value is set to a value suitable for detection of a registration mark, and a light-emitting intensity of each of the infrared light-emitting diodes 93 is adjusted so as to be gradually increased to be an appropriate light volume. At S2 as an example of a mark formation control unit, the following registration mark is formed on the surface of the conveyor belt 33 by controlling the LD control unit 106.

4.1. Feature of Registration Marks in the Exemplary Embodiment

In the exemplary embodiment, a registration mark is configured as follows. Next, the feature of the registration mark will be described.

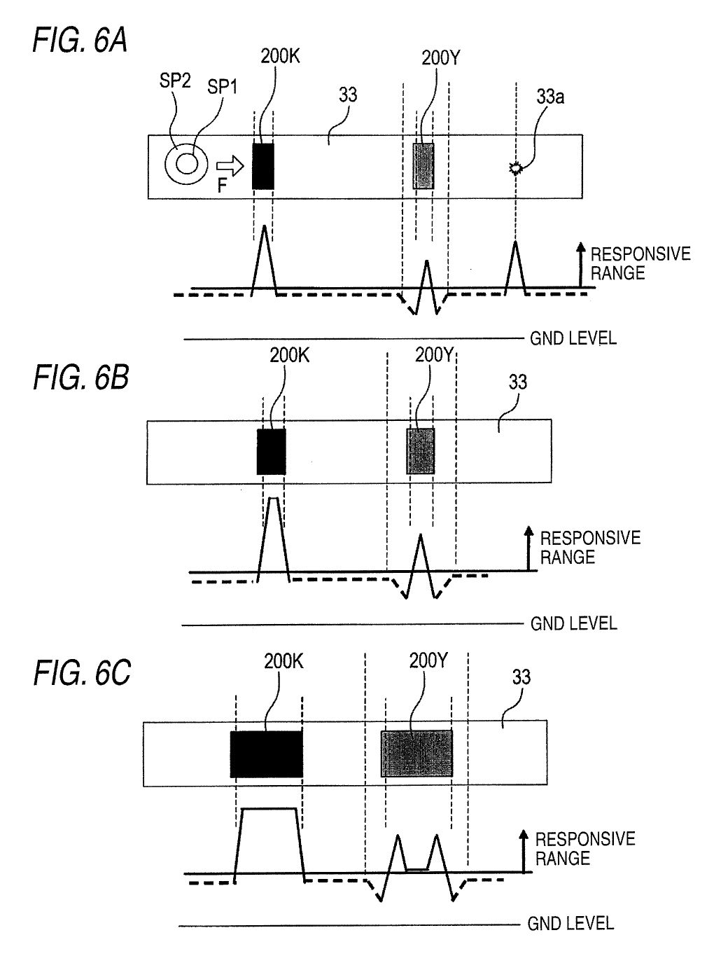

First, a case in which registration marks 200Y, 200M, 200C, and 200K corresponding to the respective colors of yellow, magenta, cyan, and black (only 200Y and 200K are shown in FIGS. 6A-6C) are formed into homochromatic strip shapes on the conveyor belt 33, will be described now with reference to FIGS. 6A-6C. FIG. 6A shows the configurations of the respective registration marks 200 and changes in detection signals with respect to the respective registration marks 200 in a case in which the widths of the respective registration marks 200 (i.e., the lengths thereof in the moving direction of the conveyor belt 33) are narrow.

As schematically shown in FIG. 6A, a specular reflection effective spot SP1 on which a specular reflecting light of an infrared light radiated from the infrared light-emitting diode 93 can be detected by the phototransistor 91, is narrower than a diffuse reflection effective spot SP2 from which a diffuse reflecting light from the conveyor belt 33 enters into the phototransistor 91. Therefore, assuming that the respective spots SP1 and SP2 relatively move in the direction of arrow F by a rotation of the conveyor belt 33, a voltage of the collector of the phototransistor 91 (i.e., a sensor output) varies as follows. Note that, as shown in FIG. 3 described above, a sensor output becomes greater as a received light volume of the phototransistor 91 decreases.

First, because diffuse reflecting light is hardly generated from the black registration mark 200K, a received light volume of the phototransistor 91 decreases in proportion to an area in which the registration mark 200K overlaps the specular reflection effective spot SP1, and a sensor output with a peak near the center of the registration mark 200K is obtained as shown in FIG. 6A.

In contrast thereto, diffuse reflecting light due to the toner enters into the phototransistor 91 from the yellow registration mark 200Y. Therefore, when the diffuse reflection effective spot SP2 starts overlapping the registration mark 200Y, a received light volume of the phototransistor 91 further increases, and after the specular reflection effective spot SP1 overlaps the registration mark 200Y to some extent, the received light volume starts to decrease. Because the registration mark sensors 90R and 90L are calibrated by the processing at S1 described above, a range in which a received light volume decreases to be slightly lower than that on the surface of the conveyor belt 33 is a responsive range of a sensor output, and a phenomenon that a received light volume increases to be higher than that on the surface of the conveyor belt 33 is not reflected to a sensor output. Therefore, a peak in a sensor output with respect to the registration mark 200Y is smaller than a peak corresponding to the registration mark 200K.

Further, when there is a scratch 33a on the conveyor belt 33, a light volume of a specular reflecting light from the conveyor belt 33 decreases on the portion of the scratch 33a, and a same level of peak is detected in some cases. Therefore, there is a disadvantage in that, if a comparator threshold value with which the registration mark 200Y can be detected is set, the scratch 33a as well may be falsely detected as a registration mark.

As schematically shown in FIG. 6B, if the widths of the registration marks 200K and 200Y are broadened, specular reflecting lights at the positions opposed to the registration marks 200K and 200Y decrease, which makes a peak of a sensor output higher. Because diffuse reflecting light does not have an effect on the black registration mark 200K, a width of a peak is broadened by that extent that the width of the registration mark 200K is broadened. However, because diffuse reflecting light increases when the width of the yellow registration mark 200Y is broadened, a peak of a sensor output does not become so high. Therefore, it is difficult to clearly distinguish the registration mark 200Y from the scratch 33a in some cases.

Then, as schematically shown in FIG. 6C, when the width of the registration mark 200Y is further broadened, diffuse reflecting light further increases, which may further lower a sensor output near the center of the registration mark 200Y. The same disadvantage occurs in the magenta and cyan registration marks 200M and 200C. Moreover, in the registration marks of chromatic colors such as yellow, magenta, and cyan, not only has the above disadvantage been created, but also another disadvantage that a so-called offset in which the center of a peak of a sensor output does not align with the center of a registration mark occurs when the specular reflection effective spot SP1 described above is not positioned at the center of the diffuse reflection effective spot SP2. Accordingly, this offset issue becomes more prominent when a width of a registration mark is broadened.

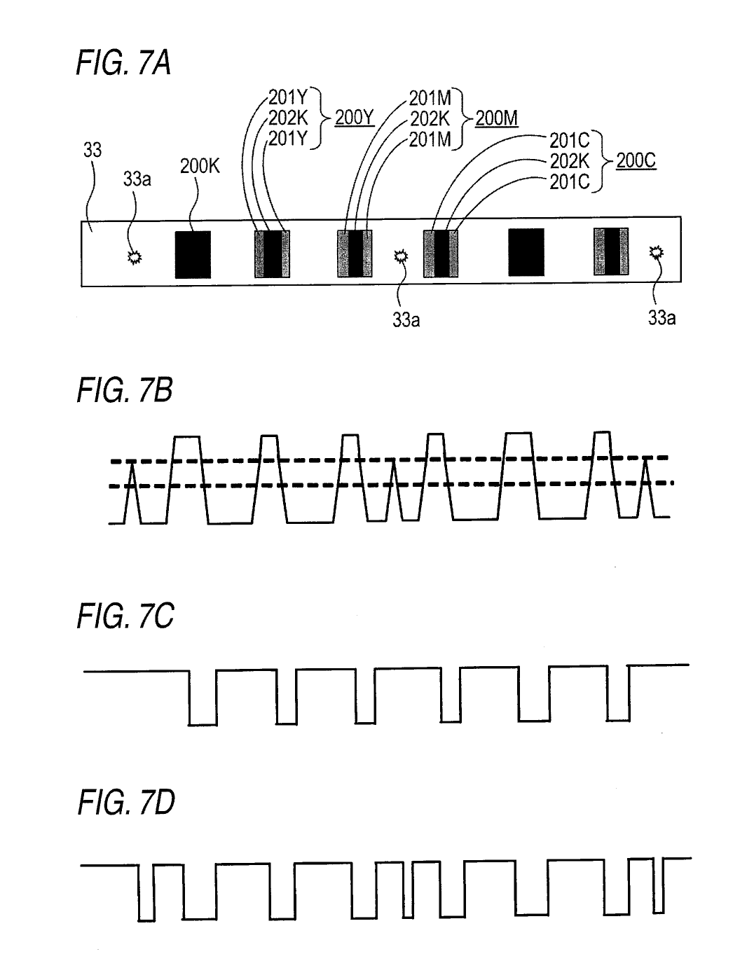

By contrast, in the exemplary embodiment, as schematically shown in FIG. 7A, the registration marks 200Y, 200M, and 200C are configured as follows. That is, as shown in FIG. 7A, in the yellow registration mark 200Y, a pair of homochromatic patterns 201Y and 201Y (i.e., detecting patterns as an example of first patterns) which are obtained by transcribing only a yellow developer, are formed on both sides along the moving direction of the conveyor belt 33 so as to sandwich a black homochromatic pattern 202K. The black homochromatic pattern 202K is an example of a diffuse reflection suppressing pattern (second pattern). In the same way as in the magenta and cyan registration marks 200M and 200C, magenta or cyan homochromatic patterns 201M or 201C are formed on the both sides along the moving direction of the conveyor belt 33 so as to sandwich a black homochromatic pattern 202K. In other words, the registration mark includes two detecting patterns and one diffuse reflection suppressing pattern.

Therefore, even if the widths of the respective registration marks 200Y, 200M, and 200C are broadened, the diffuse reflecting lights are suppressed near the centers thereof, which provides a satisfactory reading in which peaks of sensor outputs are not lowered as schematically shown in FIG. 7B. Accordingly, if a comparator threshold value is set to a height denoted by d in FIG. 7B, the outputs of the comparators 95L and 95R pick up the sensor outputs with respect to the scratches 33a as well as shown in FIG. 7D. However, if a comparator threshold value is set to be higher, such as a level denoted by c in FIG. 7B, it is possible to satisfactorily prevent the scratches 33a from being falsely detected as registration marks as shown in FIG. 7C. Additionally, the black patterns 202K prevent diffuse reflecting light, which also makes offset hard to occur.

Next, an appropriate width of each of the respective patterns (i.e., a length thereof in the moving direction of the conveyor belt 33) will be described. Note that, in the following description, the magenta registration mark 200M will be described as an example. However, the description is the same in the case of the yellow or cyan registration mark 200Y or 200C.

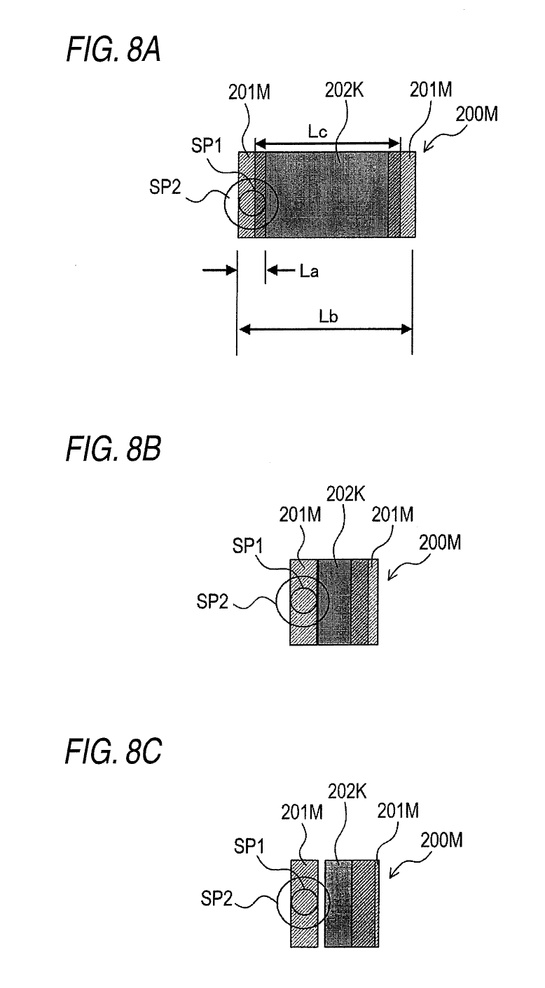

As schematically shown in FIG. 8A, when the specular reflection effective spot SP1 exactly overlaps the magenta homochromatic pattern 201M (i.e., the specular reflection effective spot SP1 has a width that is the same as the width of the homochromatic pattern 201M), it is possible to most easily detect a decrease in the specular reflecting light from the pattern 201M, and diffuse reflecting light entering from the pattern 201 is relatively less. In contrast thereto, if a width La of the pattern 201M exceeds a diameter of the specular reflection effective spot SP1, overlapping of the diffuse reflection effective spot SP2 and the pattern 201M increases, which increases diffuse reflecting light. Accordingly, the homochromatic pattern 201M is advantageously set to a width equal to the specular reflection effective spot SP1. Further, an interval between both ends of the pair of patterns 201M and 201M, i.e., a width Lb of the registration mark 200M, is advantageously set to a width which will allow scratches 33a, etc., to be clearly distinguished.
Moreover, in a case in which a color shift occurs between magenta and black, as schematically shown FIG. 8B, the black pattern 202K may be not arrayed at the center of the pair of magenta patterns 201M and 201M. On the other hand, when a gap is formed between the pattern 201M and 202K as schematically shown in FIG. 8C, a specular reflecting light from the conveyor belt 33 is detected due to the gap portion. Accordingly, the width Lb of the registration mark 200 and a width Lc of the black pattern 202K are advantageously set so as to satisfy the following formula.

Lb>2La Lc=Lb−La

Note that the diameters of the specular reflection effective spot SP1 and the diffuse reflection effective spot SP2 described above can be calculated such that known patterns are formed in black and a chromatic color on the conveyor belt 33 and changes in sensor outputs are checked.

4.2. Detection Control of Registration Mark

Returning to FIG. 5, at S2, the registration marks 200 as described above are formed on the conveyor belt 33. At S3 as an example of a pattern position estimating unit, positions at which the registration marks 200 are formed are measured as follows.

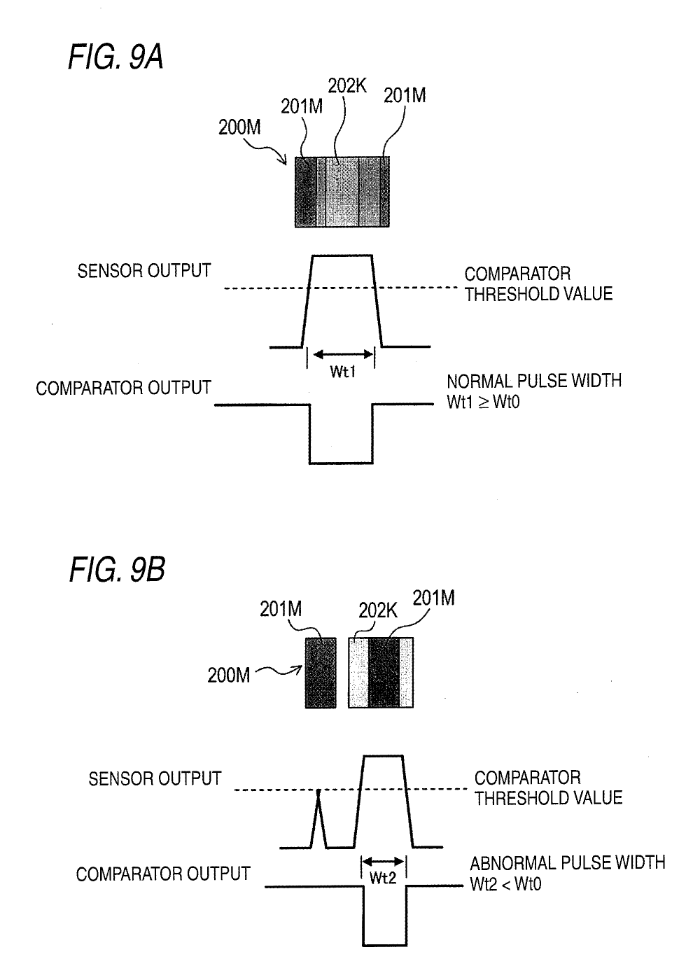

When the black pattern 202K is appropriately arrayed between the pair of magenta patterns 201M and 201M in the registration mark 200M, a sensor output varies as schematically shown in FIG. 9A. That is, the sensor output continuously exceeds the comparator threshold value over a moving period Wt0 of the conveyor belt 33 corresponding to the width Lb described above. The moving period Wt0 is set, for example, to be shorter than a period in which the conveyor belt 33 moves by just Lb. For example, in FIG. 9A, Wt1≧Wt0, where Wt1 is the period in which the conveyor belt 33 moves by just Lb. In contrast thereto, when the black pattern 202K is shifted excessively from the pair of magenta patterns 201M and 201M as schematically shown in FIG. 9B, a period Wt2 in which a sensor output exceeds the comparator threshold value is shorter than Wt0.

Then, in the processing at S3, the registration marks are measured. When a sensor output exceeds the comparator threshold value during the period Wt0 or more, it is determined that the phototransistor 91 faces the registration mark 200, and a position at which the registration mark 200 is formed is measured (estimated) on the basis of a timing of a change in outputs from the comparators 95L and 95R.

At S4, it is determined whether or not the number of the registration marks 200 formed in S2 and the number of the registration marks 200 detected in S3 are the same. If it is determined that the number of marks in S2 are the same as the number of marks in S3 (S4: Y), it is determined that all the registration marks 200 are normally detected, and after adjusting a condition for image formation at S5 on the basis of the positions at which the registration marks 200 are formed, the processing is once completed. On the other hand, if it is determined that the number of marks in S2 are not the same as the number of marks in S3 (S4: N), it is determined that an error such that a color shift is excessively large, etc., occurs, and after executing error processing at S6, the processing is once completed.

### 5. Advantages of the Exemplary Embodiment

As described above, in the exemplary embodiment, because the registration marks of chromatic colors 200Y, 200M, and 200C are configured as described above, even though the widths Lb of the registration marks 200 are broadened, it is possible to satisfactorily eliminate the effect of diffuse reflecting light. Therefore, it is possible to satisfactorily prevent the scratches 33a on the conveyor belt 33 from being falsely detected as registration marks and to prevent the occurrence of so-called offset. Further, in the laser printer 1, because the black toner is transcribed after transcribing the yellow, magenta and cyan toners, pairs of patterns 201M of a chromatic color (magenta, etc.), etc., are not transcribed on the black patterns 202K, which makes it possible to more satisfactorily suppress diffuse reflection by the black patterns 202K. Accordingly, in the laser printer 1, it is possible to remarkably correct a color shift, etc. Moreover, in the exemplary embodiment, it is possible to satisfactorily report an error such that a color shift is excessively large, etc., by the processings at S3 to S6 described above.

### 6. Additional Exemplary Embodiments

The present invention is not limited to the above-described exemplary embodiment at all. Rather, it is possible to realize the inventive concept in various modes within a range, each of which are included in the scope of the appended claims.

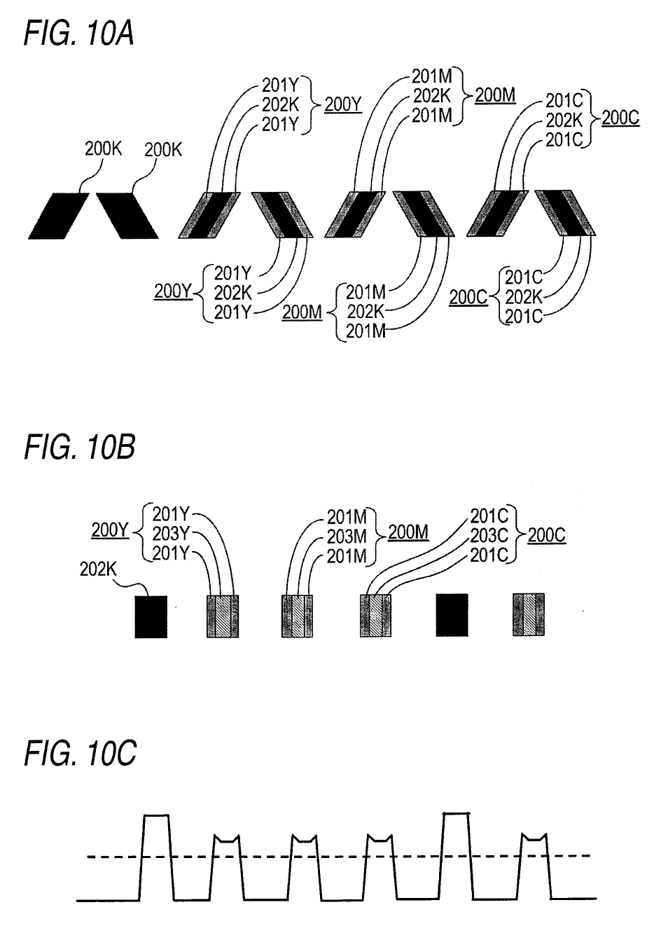

According to another exemplary embodiment of the present invention, as shown in FIG. 10A, the respective registration marks 200 may be formed in a slanted shape. The slanted shape broadens toward one end such that the registration marks 200 include a pair of rhombuses tilted in different directions from one another. In this case, provided that an interval between detections of the pair of registration marks 200 for a same color is measured, it is possible to detect a shift in the width direction of paper.

Further, in the above-described exemplary embodiment, the diffuse reflection suppressing pattern is composed of the black pattern 202K. However, various configurations of the diffuse reflection suppressing pattern may be provided. For example, as illustrated in FIG. 10B, according to another exemplary embodiment, a halftone pattern 203Y in which the toner forming the patterns is transcribed in lesser concentrations than the patterns 201Y may be formed between a pair of patterns 201Y and 201Y of chromatic colors, etc. That is, provided that a toner is transcribed in low concentration, it is possible to suppress diffuse reflection.

In this case, as shown in FIG. 10C, the sensor outputs are slightly lowered near the centers of the registration marks 200, which slightly lowers a detection accuracy of the sensor. However, it is still possible to satisfactorily eliminate the effect of diffuse reflecting light. Further, in this case, because the toner of chromatic color is transcribed in low concentration in the pattern 203Y, etc., it is possible to save the toner, and the registration marks 200 of the respective colors are respectively formed by the same toners, which makes it more difficult to have a misregistration between the patterns 201Y and 203Y, etc. Further, in this case, the present inventive concept can be applied to an apparatus that forms a color image in three colors of yellow, magenta, and cyan.

### 7. Modifications of the Exemplary Embodiments

Further, in the above-described exemplary embodiment, the inventive concept is applied to a direct tandem system color laser printer. However, the present inventive concept is not limited thereto, and may also be applied to a four-cycle system electrophotographic image forming apparatus. Moreover, in the above-described exemplary embodiment, the registration marks 200 are formed on the conveyor belt 33. However, the present inventive concept is not limited thereto, and registration marks may be formed on another image carrier (fox example, an intermediate transcriptional body, a photoconductor drum, etc.) rotating in association with an image-forming operation of the image forming unit 10.

Registration marks according to exemplary embodiments of the present invention are formed by transcribing developers of a plurality of colors onto a surface of an image carrier, and are scanned on the basis of a specular reflecting light of a light radiated so as to aim at the image carrier, and in the registration marks respective detecting patterns which are respectively formed for each of the plurality of colors by transcribing a single developer of chromatic color, that reflect a position at which the developer of the color is transcribed, the respective detecting patterns are respectively formed on both sides along a moving direction of the image carrier so as to sandwich a diffuse reflection suppressing pattern. A diffuse reflection component in a light reflected by the diffuse reflection suppressing pattern is less than a diffuse reflection component in a light reflected by the detecting patterns of the color, and a specular reflection component in a light reflected by the diffuse reflection suppressing pattern is less than a specular reflection component in a light reflected by the surface of the image carrier.

In the registration mark according to exemplary embodiments of the present invention, the detecting patterns which are formed by transcribing a single developer of chromatic color are formed on the both sides along a moving direction of the image carrier so as to sandwich a diffuse reflection suppressing pattern. A diffuse reflection component in a light reflected by the diffuse reflection suppressing pattern is less than a diffuse reflection component in a light reflected by the detecting patterns, and a specular reflection component in a light reflected by the diffuse reflection suppressing pattern is less than a specular reflection component in a light reflected by the surface of the image carrier. Therefore, provided that a set of the diffuse reflection suppressing patterns and the detecting patterns on both sides thereof are handled as a registration mark corresponding to the chromatic color, a diffuse reflecting light is suppressed near the center of the registration mark, and a specular reflecting light as well decreases to an extent that the surface of the image carrier can be distinguished from the registration mark.

Accordingly, in the registration marks according to exemplary embodiments of the present invention, even if a distance between the both ends of the pair of detecting patterns (which corresponds to a width of the registration mark corresponding to the chromatic color) is increased, it is possible to satisfactorily eliminate the effect of diffuse reflecting light. Therefore, it is possible to satisfactorily prevent scratches on the image carrier from being falsely detected as registration marks and to prevent the occurrence of so-called offset.

In the registration marks according to exemplary embodiments of the present invention, the diffuse reflection suppressing pattern may be formed by transcribing a black developer. A pattern formed of a black developer generates little specular reflecting light and diffuse reflecting light. Therefore, in a case in which a diffuse reflection suppressing pattern is formed by transcribing a black developer as described above, a diffuse reflecting light is suppressed, which further improves a detection accuracy of the registration mark.

Further, the diffuse reflection suppressing pattern may be formed by transcribing a developer forming the detecting patterns in lesser concentrations than the detecting patterns. In this way, by utilizing the same developer as that for the detecting patterns, it is possible to form a diffuse reflection suppressing pattern which allows a reflected light thereof to contain less diffuse reflection component by transcribing the developer in low concentration. In this case, because the developer is transcribed in low concentration in the diffuse reflection suppressing pattern, it is possible to save the developer. Further, because the diffuse reflection suppressing pattern is formed by using the same developer as the detecting patterns, misregistration between the diffuse reflection suppressing pattern and the detecting patterns will also hardly occur.

Further, an image forming apparatus according to exemplary embodiments of the present invention includes an image forming unit for forming images by transcribing developers of a plurality of colors, an image carrier that rotates in association with an image-forming operation of the image forming unit, a mark formation control unit for controlling the image forming unit to form the registration marks onto the surface of the image carrier, an irradiating unit for irradiating the registration marks with light when the registration marks are formed onto the image carrier, and a specular reflecting light detecting unit for detecting a specular reflecting light of a light radiated so as to aim at the image carrier by the irradiating unit.

In the image forming apparatus according to exemplary embodiments of the present invention, the mark formation control unit controls the image forming unit to form the registration marks onto the surface of the image carrier rotating in association with an image-forming operation of the image forming unit. Accordingly, the irradiating unit irradiates the registration marks with light when the registration marks are formed onto the image carrier, and the specular reflecting light detecting unit detects a specular reflecting light of a light radiated so as to aim at the image carrier. Therefore, it is possible to form on the image carrier registration marks capable of eliminating the effect of diffuse reflecting light as described above, and to correct a color shift, etc., by detecting the registration marks via the specular reflecting light detecting unit.

The image forming unit has four transcribing units that individually transcribe developers of four colors of cyan, yellow, magenta, and black, and one of the four transcribing units corresponding to the black developer may be provided most downstream in the moving direction of the image carrier, and the mark formation control unit may form on the surface of the image carrier the registration marks in which the diffuse reflection suppressing patterns are respectively formed by the black developer. In this case, because the developers of chromatic colors are not transcribed on the black diffuse reflection suppressing patterns, it is possible to more satisfactorily suppress the diffuse reflection, which makes it possible to more satisfactorily correct a color shift, etc.

Then, in this case, the image forming apparatus may further include a pattern position estimating unit for estimating a position at which the detecting patterns are formed on the basis of the period in which the light volume decreases when a period in which a light volume of a specular reflecting light detected by the specular reflecting light detecting unit decreases to be less than a threshold value continues over a moving period of the image carrier corresponding to a distance between both ends of the pair of detecting patterns formed so as to sandwich the diffuse reflection suppressing pattern.

In a case in which an amount of color shift by the image forming means is great, a gap is formed between one of the pair of detecting patterns formed of the developer of chromatic color and the diffuse reflection suppressing pattern formed of the black developer, which may divide the pattern into two apparent patterns. In contrast thereto, in a case in which the pattern position estimating unit described above is provided, when a period in which a light volume of a specular reflecting light detected decreases to be less than a threshold value continues over a moving period of the image carrier corresponding to a distance between the both ends of the pair of detecting patterns, a position as a registration mark is estimated for the first time. Accordingly, in this case, when an amount of color shift is great, it is possible to report an error, etc., which makes it easier to prevent false detection.

As indicated above, the present invention has been shown and described with reference to certain exemplary embodiments thereof. However, it will be understood by those skilled in the art that various changes in form and details may be made therein without departing from the spirit and scope of the invention as defined by the appended claims.

What is claimed is:

1. A method for forming a registration mark comprising two first patterns and one second pattern on an image carrier, the method comprising:
forming two first patterns on the image carrier; and
forming a second pattern on the image carrier between the two first patterns;
wherein a specular reflection component in a light reflected by the second pattern is less than a specular reflection component in a light reflected by the image carrier; and
wherein a diffuse reflection component in a light reflected by the second pattern is less than a diffuse reflection component in a light reflected by the first pattern.

2. The method according to claim 1, wherein the second pattern is formed by using a black developer.

3. The method according to claim 1,
wherein the first pattern and the second pattern are formed by using the same developer; and
wherein density of developer in the second pattern is lesser than density of developer in the first pattern.

4. An image forming apparatus comprising:
an image forming unit which forms images by using developers of a plurality of colors;
an image carrier that rotates in association with an image-forming operation of the image forming unit;
a mark formation control unit which controls the image forming unit to form at least one registration mark on the image carrier, the registration mark comprising two first patterns and one second pattern, the second pattern is located between the two first patterns;
an irradiating unit which irradiates the registration mark with light; and
a light detecting unit which detects a light reflected by the registration mark,
wherein a specular reflection component in a light reflected by the second pattern is less than a specular reflection component in a light reflected by the image carrier, and
wherein a diffuse reflection component in a light reflected by the second pattern is less than a diffuse reflection component in a light reflected by the first pattern.

5. The image forming apparatus according to claim 4, wherein the second pattern is formed by using a black developer.

6. The image forming apparatus according to claim 4,
wherein the first pattern and the second pattern are formed by using the same developer: and
wherein density of developer in the second pattern is lesser than density of developer in the first pattern.

7. The image forming apparatus according to claim 4, wherein
the image forming unit comprises four transcribing units that individually form images by using developers of cyan, yellow, magenta, and black, respectively, and the transcribing unit which corresponds to the black developer is provided most downstream in the moving direction of the image carrier.

8. The image forming apparatus according to claim 7, further comprising:
a position estimating unit which estimates a position at which the registration mark is formed on a basis of a period in which the light volume decreases.

9. The image forming apparatus according to claim 8, wherein if the period in which the light volume decreases is less than a threshold value for a moving period of the image carrier which corresponds to a width of the registration mark, the position estimating unit determines that the registration mark is present.

10. An image forming apparatus comprising:
at least two processing units;
an image carrier;
a control unit which controls one of the at least two processing units to form on the image carrier two first patterns by using a first developer, and the other of the at least two processing units to form a second pattern by using a second developer, the second pattern is located between the two first patterns,
wherein a specular reflectivity of the second developer is less than a specular reflectivity of a surface of the image carrier, and
wherein a diffuse reflectivity of the second developer is less than a diffuse reflectivity of the first developer.

11. The image forming apparatus according to claim 10, wherein the second developer is a black toner.

12. The image forming apparatus according to claim 11, wherein the second developer is a developer of a chromatic color.

13. The image forming apparatus according to claim 10,
wherein the first pattern and the second pattern are formed by using the same developer; and
wherein density of developer in the second pattern is lesser than density of developer in the first pattern.

14. The image forming apparatus according to claim 10,
wherein the registration mark is scanned by a registration mark sensor configured to scan the registration mark in a scanning direction,
wherein Lb>2*La and Lc=Lb−La, where Lc denotes a width of the second pattern in the scanning direction, La denotes a width of each of the first patterns in the scanning direction, and Lb denotes a width of the two first patterns and the second pattern combined.

15. The image forming apparatus according to claim 10, wherein the two first patterns and the second pattern are each rhombus-shaped.

16. The image forming apparatus according to claim 10, further comprising:
a registration mark sensor comprising a light emitting diode and a phototransistor; and
a detector which, based on an output from the registration mark sensor, determines a position of the registration mark on the image carrier.
